(19) United States
(12) Patent Application Publication
(10) Pub. No.: US 2007/0145093 A1
(43) Pub. Date: Jun. 28, 2007

(54) Stapler

(75) Inventor: Takeshi Matsukawa, Tokyo (JP)

Correspondence Address: BINGHAM MCCUTCHEN LLP, 2020 K Street, N.W., Intellectual Property Department, WASHINGTON, DC, 20006, US

(73) Assignee: PLUS STATION CORPORATION

(21) Appl. No.: 11/453,838

(22) Filed: Jun. 16, 2006

(30) Foreign Application Priority Data
Dec. 28, 2005 (JP) 2005-379227

(51) Int. Cl. B25C 5/06

(52) U.S. Cl. 227/120

(57) ABSTRACT

The invention provides a stapler that the irregular movement of a bound object may be deterred by holding steadily the bound object with the lower side of a staple storing frame and a paper placing stand, a staple pressure lowering plate may push staples out effectively to reach a dead point in the upper and lower stroke, and the right and left legs of the staple may be pushed out in a balanced manner from the staple storing frame. The stapler comprises the staple storing frame having a staple discharge port, a staple receiving board for receiving a discharged staple, and the paper placing stand for placing the bound object, wherein a protruded part is formed near the discharge port of the staple storing frame and a recessed part is formed in a position that is on the paper placing stand and corresponds to the protruded part.

### BACKGROUND OF THE INVENTION

1. Field of the Invention

The present invention relates to a stapler which bends leg parts of a staple so as to be flat.

2. Description of Prior Art

There are two types of general staplers, one bends leg parts of a staple so as to be curved and the other bends them so as to be flat when a bound object is clinched. The thickness of the bound object is increased by that corresponding to the curve of leg parts in the case of the stapler which bends leg parts of the staple so as to be curved, and thus, the stapler which bends leg parts of the staple so as to be flat is becoming common. For instance, the “OFFICE STAPLER” disclosed in Examined Utility Model Registration No. 2524275 is reported as the stapler which bends leg parts of the staple so as to be flat.

Regarding the conventional stapler which bends leg parts of the staple so as to be flat, each surface of a lower surface of a staple storing frame having a staple discharge port and an upper surface of a paper placing stand for placing the bound object are formed flat, thus, the staple is occasionally incompletely clinched because tips of the staple becomes in a state of opening by the spring back when a hard wire staple was used. This is that, in the case that a large stack of paper is bound, staples can not be pushed out if the pushing force of a staple pressure lowering plate which discharges the staple from a discharge port is small, and in the case that a hard wire staple is used, tips of the staple becomes in a state of opening without being pushed to paper surface because the binding operation finishes binding before the stapler presses completely so that tips of the staple do not spring back.

The above described incompletely clinched state means five items of “spread opening of a staple leg part”, “height abnormality in staple clinch”, “twisting of staple leg parts”, “incompletely clinch”, and “reversed clinch”. For instance, the “spread opening of a staple leg part” means the state that a leg part of a staple leaves and opens from the bottom surface of the paper in a state of binding. The “height abnormality in staple clinch” means the state that the height of the clinched leg exceeds a prescribed length from the bottom surface of the paper in a state of binding. The “twisting of staple leg parts” means the state that leg parts are not on a straight line and the length between a line connected penetrated points of staple leg parts and the tip of the leg part exceeds a prescribed length when looked from the back surface in a state of binding. The “incompletely clinch” means the state that a staple pressure lowering plate slips over a crown part of staples when the staple is pushed out and then the binding finishes in a no clinched imperfect state. And, the “reversed clinch” means the state that one leg part of the staple turns to outward for the reason that the position of a staple exit of a frame and an anvil are out of alignment.

With respect to these, some techniques for preventing the state that the staple is incompletely clinched being open the tip of the staple when the bound object is bound by the stapler are proposed as a part of the art of the stapler which bends leg parts of the staple so as to be curved.

For instance, for preventing that the staple is incompletely clinched being open the tip of the staple, there is a technique that a protruded part, not flat, is formed in a staple storing frame having a staple discharge port, as the “STAPLE DRIVING APPARATUS” disclosed in Published Utility Model Application No. 61-166776. This prevents the state that the staple is incompletely clinched being open the tip of the staple by binding the bound object in the state of curving with the protruded part. However, this stapler does not have a recessed part on a paper placing stand, which corresponds to the protruded part, the protruded part only holds the bound object (paper etc.), therefore the irregularly movement of the bound object can not be prevented.

Moreover, there is also a technique that a protruded part, not flat, is formed in the paper placing stand where the bound object is placed. For instance, there is a stapler that a protruding part is formed forwardly from a guide groove which receives a discharged staple, as the “CLINCHING TABLE FOR STAPLER” disclosed in Published Utility Model Application No. 6-83281. However, the bound object may be caught to the protruding part when the bound object is placed on the paper placing stand, and a slippage may be caused because the bound object moves irregularly in front and rear direction.

### SUMMARY OF THE INVENTION

As described above, there is a problem that the bound object moves irregularly when it was held. And the bound object does not be curved sufficiently in the state that the bound object is held by the protruded part of either the staple storing frame having the staple discharge port or the paper placing stand for placing the bound object, consequently, the tip of the leg part opens and can not be clinched completely if the stapler which bends leg parts of the staple so as to be flat is used.

The present invention is made in view of problems of the above-mentioned prior arts and is intended to provide a stapler that the irregular movement of the bound object may be deterred by holding steadily the bound object with the lower side of the staple storing frame and the paper placing stand, the staple pressure lowering plate may push staples out effectively to reach a dead point in the upper and lower stroke, and as a result, the right and left legs of the staple may be pushed out in a balanced manner from the staple storing frame.

The present invention in claim 1 is a stapler comprising a staple storing frame having a staple discharge port, a staple receiving board for receiving a discharged staple, and a paper placing stand for placing a bound object, wherein a protruded part is formed near the staple discharge port of the staple storing frame and a recessed part is formed in a position that is on the paper placing stand and corresponds to the protruded part formed in the staple storing frame.

The present invention in claim 2 is a stapler of claim 1, wherein the recessed part is formed to be larger than the protruded part.

The present inventions in claim 3 and 4 are staplers of claim 1 or 2, wherein the protruded part and recessed part are formed into a square shape respectively.

According to the present invention in claim 1, the invention is the stapler comprising the staple storing frame having the staple discharge port, the staple receiving board for receiving the discharged staple and the paper placing stand for placing the bound object, wherein the protruded part is formed near the staple discharge port of the staple storing frame and the recessed part is formed in the position that is on the paper placing stand and corresponds to the protruded part formed in the staple storing frame, thus, the bound object may be steadily held, without moving irregularly in front/rear and left/right direction, with the protruded part of the lower side of the staple storing frame and the recessed part of the paper placing stand. In addition, since the stapler of the present invention may hold the bound object being gently curved, the slight space is produced in between sheets every time when the staple penetrates the held bound object and the penetration resistance is dispersed, thus, the bound object may be bound certainly.

Additionally, the stapler of the present invention may clinch any hardness of staple such as a hard wire staple or soft wire staple so that the tips of them face the paper surface. Moreover, a spring backed staple may be forcibly incurved the tip thereof. The present invention may be economical because the parts cost are hardly increased.

According to the present invention in claim 2, the recessed part is formed to be larger than the protruded part, thus, the irregular movement of the bound object may be extremely diminished.

According to the present inventions in claim 3 and 4, the protruded part and recessed part are formed into a square shape respectively, thus, the irregular movement in front/rear and left/right direction of the bound object may be extremely diminished.

### BRIEF DESCRIPTION OF THE DRAWINGS

FIG. 1 is a vertical sectional view of a stapler of the present invention;

FIG. 2 is a view illustrating a staple storing frame and a paper placing stand of the stapler of the present invention; and

FIG. 3 is a view illustrating the state that the stapler of the present invention holds the bound object.

### BEST MODE FOR CARRYING OUT THE INVENTION

The present invention is a stapler comprising a staple storing frame having a staple discharge port, a staple receiving board for receiving a discharged staple and a paper placing stand for placing a bound object, wherein a square shaped protruded part is formed near the staple discharge port of the staple storing frame and a square shaped recessed part larger than the protruded part is formed in a position that is on the paper placing stand and corresponds to the protruded part formed in the staple storing frame.

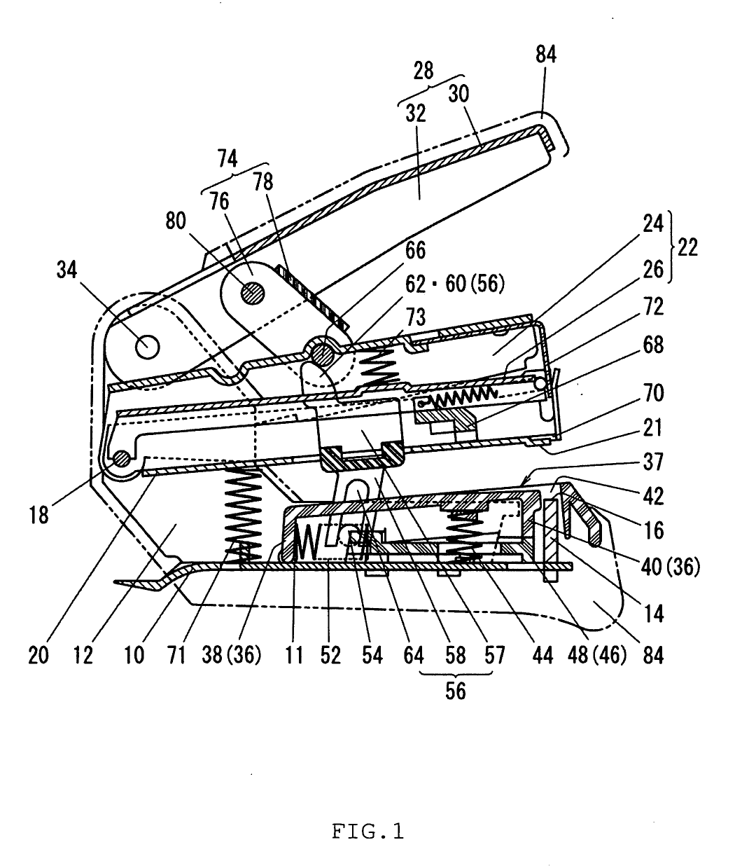

Hereinafter, a preferred embodiment of the present invention will be described with referent to the drawings. FIG. 1 is a vertical sectional view of a stapler. The structure of the stapler which bends leg parts of a staple so as to be flat will be briefly described with referent to FIG. 1.

The stapler comprises a base frame 10 having a paper placing stand 36, a staple storing frame 20 which stores staples and has a staple discharge port 70, an operation frame 22 having a staple pressure lowering plate 72 for pressing the stored staple, and a handle frame 28 for user operating, where the staple storing frame 20, the operation frame 22 and the handle frame 28 are rotatably supported to the base frame 10 and a mediation piece 74 which functions as a lever is provided between the handle frame 28 and the operation frame 22.

The base frame 10 and the paper placing stand 36 of the stapler are described below. A staple receiving board 14 having a staple guide groove 16 is fixed on the upper surface of the forward end of the base frame 10 and a support member 12 is vertically arranged on the rearward end thereof to oppose the staple receiving board 14. A spindle 18 which supports the staple storing frame 20 for storing staples and the operation frame 22 so as to be rotatable is pivotally fitted to the rearward end part of the support member 12. A support shaft 34 which supports the handle frame 28 so as to be rotatable is provided in a position that is the rearward end part of the support member 12 and that is the upper part of the spindle 18. And a resin cover 84 is externally fit to the base frame 10 and the handle frame 28.

A vertical hole 42 where the staple receiving board 14 provided in the base frame 10 is inserted is provided at the forward end of the paper placing stand 36 and the paper placing stand 36 is supported with a shaft hole 11 formed in near the center of the support member 12 so that the forward end part thereof elevates freely. A first resilient member 44, a compression spring, is arranged in a position that is between the rear surface of the paper placing stand 36 and the base frame 10 and that is near the staple receiving board 14. Both ends of the first resilient member 44 are brought into contact with the rear surface of the paper placing stand 36 and the base frame 10 respectively and energize in separating and opening direction that the forward end of the paper placing stand 36 moves upwards. Moreover, in the case of no pressing to the paper placing stand 36 by the staple storing frame 20 as shown in FIG. 1, the guide groove 16 positioned on the upper surface of the staple receiving board 14 positions at a position buried in the vertical hole 42.

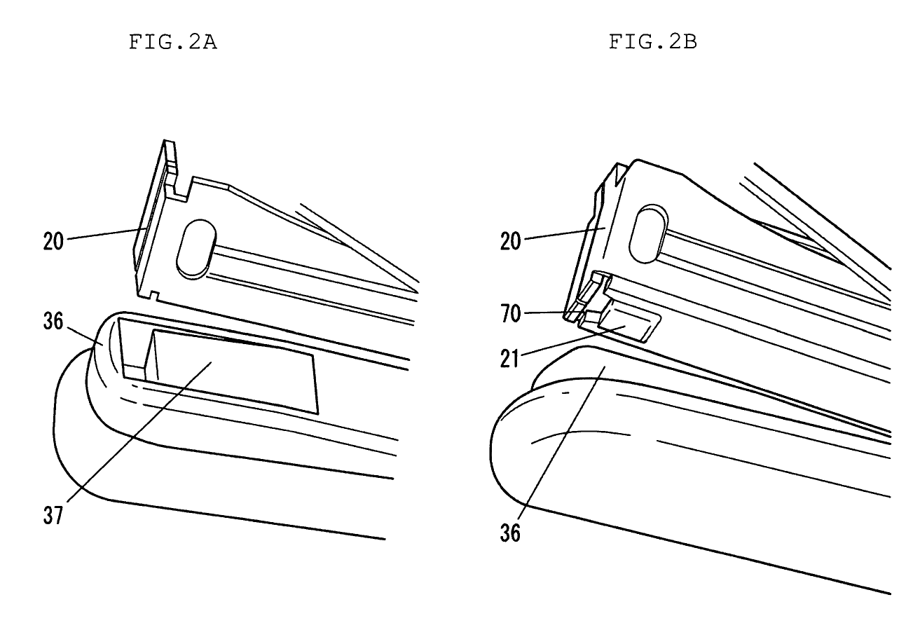

As shown in FIG. 2A, a square shaped recessed part 37 is formed in a position that is the upper surface of the paper placing stand 36 and contacts to the edge side of the vertical hole 42. Additionally, the recessed part 37 is gradually deeper toward the vertical hole 42. The depth of the deepest part of the recessed part 37 is approximately same length as the thickness of a protruded part 21 formed in the lower surface of the staple storing frame 20 described below. And, the recessed part 37 is formed to be larger than the protruded part 21 formed in the lower surface of the staple storing frame 20 so that the protruded part 21 is buried.

A regulating frame 46 is assembled in a position that is below the paper placing stand 36 and that is on the upper surface of the base frame 10 so as to be slidable in front and rear direction of the base frame 10. A second resilient member 52, a compressing spring, is placed between the rearward end part of the regulating frame 46 and a rear part piece 38 of the rearward end side of the paper placing stand 36, and the regulating frame 46 is energized by the energizing force of the second resilient member 52 so as to slide to forward of the base frame 10. And, when the regulating frame 46 positions forward, a frame piece 48 formed at the forward end of the regulating frame 46 positions directly below the forward end piece 40 which is the edge of the vertical hole 42 of the paper placing stand 36 and regulates the moving down of the paper placing stand 36 by receiving and supporting the forward end piece 40.

Additionally, the regulating frame 46 is equipped with standing members (not illustrated) facing each other with the rear part of the paper placing stand 36, and a convexed protruding piece 54 engaging with an inclined long hole 64 formed in a leg member 58 of a linking member 56 described below is provided at both inside walls of the standing member, respectively.

The linking member 56 is assembled to the staple storing frame 20 so as to be slidable in front and rear direction, where a main linking frame 57 of the linking member 56 is formed into a substantially groove shape and holds near the center of the staple storing frame 20. And a leg member 58 which is a lower part of the linking member 56 is formed in the lower surface of the main linking frame 57 so as to protrude downward, and an inclined long hole 64 which is long in the direction of the staple storing frame 20 and the regulating frame 46 and inclines toward from the forward to the rearward of the base frame 10 is formed in the leg member 58. Moreover, a pressure receiving piece 60 is formed in the upper rear end side of the main linking frame 57 so as to protrude upward over the upper edge of the staple storing frame 20, and a circular shaped forward edge 62 is formed at the forward part of the pressure receiving piece 60.

The operation of the regulating frame 46 is described below. When the operation frame 22 lowers to the staple storing frame 20 with rotating around the spindle 18, the staple storing frame 20 also lowers with the lowering of the operation frame 22 and brings into contact with the paper placing stand 36. When the operation frame 22 lowers further, a pressing bar 66 (described below) provided near the center of the operation frame 22 lowers along the forward edge 62 formed into a circular arc shape. The forward edge 62 formed in the linking member 56 is pressed with the lowering of the pressing bar 66, and the linking member 56 is pressed behind the staple storing frame 20. Therefore, the linking member 56 slides toward the rearward of the staple storing frame 20, the regulating frame 46 is pressed toward the rearward through the protruding piece 54 with the sliding of the linking member 56, and the regulating frame 46 slides toward the rearward against the energizing of the second resilient member 52. Accordingly, the frame piece 48 formed at the forward end of the regulating frame 46 positions away from directly below the forward end piece 40 which is the end of the vertical hole 42 of the paper placing stand 36, and the lowering regulation of the paper placing stand 36 by the regulating frame 46 is released.

The staple storing frame 20 has a well-known structure in which a pusher 68 is slidably fitted so that staples are put into the staple discharge port 70 at the forward end thereof. The end parts of a third resilient member 71, a compression spring, is brought into contact with the rear lower surface of the staple storing frame 20 and the rear upper surface of the base frame 10, and the opening between the staple storing frame 20 and the base frame 10 is kept by the energizing force of the third resilient member 71. Moreover, the operation frame 22 comprises a main frame 24 having a staple pressure lowering plate 72 for pressing the staple at the forward end thereof and a supporting frame 26 arranged inside of the main frame 24, and a forth resilient member 73 which is a compression spring having an energizing force harder than that of the third resilient member 71 is provided between the main frame 24 and the supporting frame 26.

Additionally, as shown in FIG. 2B, a square shaped protruded part 21 is formed in a position that is the lower surface of the staple storing frame 20 and that is near the staple discharge port 70, and the protruded part 21 may be buried in the recessed part 37 formed in the paper placing stand 36 when the staple storing frame 20 is lowered. Namely, the height of the protruded part 21 is approximately same as the depth of the recessed part 37 of the paper placing stand 36 and the protruded part 21 has a square shape smaller than the recessed part 37.

The pressing bar 66 is supported in near the center of the main frame 24, where the pressing bar 66 presses the forward edge 62 of the pressure receiving piece 60 of the linking member 56 which is slidably engaged with the staple storing frame 20 in front and rear direction. One end of a mediation piece 74 is rotatably supported by the pressing bar 66 as a pivot.

The mediation piece 74 is formed by oppositely and continuously arranging a central piece 78 and a side piece 76. One end of the side piece 76 is rotatably supported to the main frame 24 of the operation frame 22 by the pressing bar 66. The other end of the side piece 76 is placed above the rear upper side of the pressing bar 66 and is rotatably supported by the shaft 80 pivoted to the handle side piece 32 of the handle frame 28 supported by the support shaft 34.

The handle frame 28 comprises the handle side piece 32 and a handle central piece 30 oppositely arranged along the longitudinal direction of the handle side piece 32, where the rear end part of the handle side piece 32 is rotatably supported by the support shaft 34 fitted to the support member 12. Also, the mediation piece 74 is supported by the shaft 80 pivotably fitted to the slightly rear side of the handle frame 28 and the pressing bar 66 supported near the center of the operation frame 22, respectively, and the forward end side of the handle frame 28 is separated from the operation frame 22 by the mediation piece 74.

The movement of each part at the time of operating the stapler is described below. When the forward end side of the handle frame 28 is pressed down to the base frame 10 centering the support shaft 34, the handle frame 28 presses the pressing bar 66 down through the shaft 80 and the mediation piece 74. The forward end side of the main frame 24 rotates and lowers around the spindle 18 as a fulcrum with the pressing of the pressing bar 66, since the pressed pressing bar 66 is supported by the main frame 24 of the operation frame 22. And, the forward end sides of the operation frame 22 having the main frame 24 and the staple storing frame 20 rotate and lower around the spindle 18 with the lowering of the main frame 24 because the energizing force of the third resilient member 71 is weaker than the force of the forth resilient member 73.

And then, the linking member 56 having the inclined long hole 64, which is provided in the staple storing frame 20, lowers with the rotating and lowering of the operation frame 22, the protruding piece 54 is pressed backward by the inclined long hole 64, the regulating frame 46 having the protruding piece 54 is slid back against the energizing force of the second resilient member 52, and a space is produced directly below the forward end piece 40 of the paper placing stand 36. In this state, the forward end side of the staple storing frame 20 which is pressed down by the pressing bar 66 is bought into contact with the paper placing stand 36, and then, presses the paper placing stand 36 downwardly. The forward end side of the paper placing stand 36 lowers against the energizing of the first resilient member 44 thereby, and the guide groove 16 of the staple receiving board 14 assembled to the case frame 10 is relatively protruded at an upper end position of the vertical hole 42 of the paper placing stand 36.

The rotating and lowering of the operation frame 22 is regulated by bringing the staple storing frame 20 into contact with the forward end of the staple receiving board 14 through such as the bound object. And then, by continuing the rotation operation of the handle frame 28 centering the support shaft 34, the main frame 24 of the operation frame 22 lowers while rotating centering around the spindle 18 against the energizing of the forth resilient member 73 and approaches the staple storing frame 20. The staple pressure lowering plate 72 formed at the forward end of the main frame 24 presses a staple which is stored in the staple storing frame 20 thereby, the staple is punched out from the staple discharge port 70 formed at the forward end of the staple storing frame 20. And then, leg parts of the staple penetrated the bound object which is held with the paper placing stand 36 and the staple storing frame 20 are pressed by the staple receiving board 14 and are clinched flatly so that the bound object is bound.

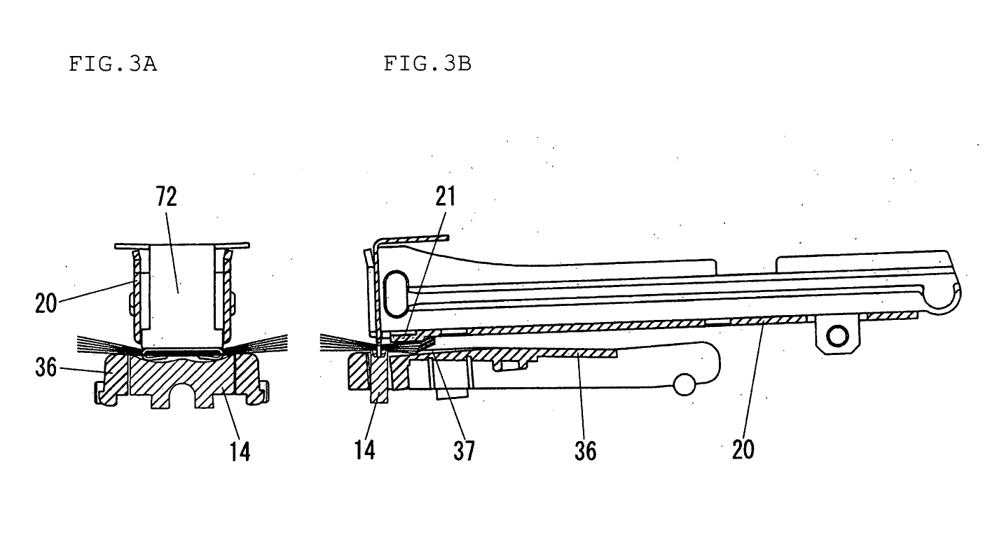

FIGS. 3A and 3B show the state that the forward end side of the staple storing frame 20 rotates and lowers then holds the bound object after the bound object is placed on the paper placing stand 36. FIG. 3A is a front view of the front end side of the stapler and the FIG. 3B is a side view of the stapler.

The bound object (paper etc.) may be tightly held by the square shaped protruded part 21 formed in the lower surface of the staple storing frame 20 and the square shaped recessed part 37 formed in the upper surface of the paper placing stand 36 without the slippage of the bound object toward the depth or the right and left direction and the irregular movement of the bound object.

In addition, as shown in FIGS. 3A and 3B, the difference in level between the periphery of the protruded part 21 formed in the lower surface of the staple storing frame 20 and the periphery of the square shaped recessed part 37 formed in the upper surface of the paper placing stand 36 is produced, thus, the stapler of the present invention may hold the bound object being gently curved. And as a result, a slight space is produced in between sheets of the held bound object at the near both side ends of the staple discharge port 70 of the staple storing frame 20. Therefore, leg parts of the staple punched out from the staple discharge port 70 formed in the forward end of the staple storing frame 20 may penetrate the bound object in good balance and may bind it certainly, because the penetrate resistance of leg parts of the staple is dispersed by the space produced in between sheets of the bound object.

Accordingly, even a stapler which bends leg parts of the staple so as to be flat may certainly prevent five items which show states that the staple is incompletely clinched, such as “spread opening of a staple leg part”, “height abnormality in staple clinch”, “twisting of staple leg parts”, “incompletely clinch”, and “reversed clinch”.

For instance, the state of the “spread opening of a staple leg part” that the leg part of the staple leaves and opens from the bottom surface of the paper in a state binding, the state of the “height abnormality in staple clinch” that the height of the clinched leg exceeds a prescribed length (about 0.7 mm) from the bottom surface of the paper in a state of binding, the state of the “twisting of staple leg parts” that leg parts are not on a straight line and the length between a line connected penetrated points of staple leg parts and the tip of the leg part exceeds a prescribed length (about 0.5 mm) when looked from the back surface in a state of binding, the state of the “incompletely clinch” that the staple pressure lowering plate 72 slips over the crown part of staples when the staple is pushed out and then the binding finishes in a no clinched imperfect state, and the state of the “reversed clinch” that one leg part of the staple turns to outward for the reason that the position of the staple discharge port 70 of the staple storing frame 20 and the staple receiving board 14 are out of alignment may be prevented for clinching incompletely.

According to the present invention described above, the irregular movement of the bound object may be deterred and the staple pressure lowering plate may push staples out effectively to reach a dead point in the upper and lower stroke by the bound object being steadily held with the lower side of the staple storing frame and the paper placing stand, and as a result, the right and left legs of the staple may be pushed out in a balanced manner from the staple storing frame. Therefore, the stapler that the bound object may be bound certainly in each case that the leg parts of the staple is bend so as to be flat or curved is provided.

While there has been described what is at present considered to be preferred embodiment of the invention, it will be understood that various modifications may be made therein.

What is claimed is:

1. A stapler comprising:
a staple storing frame having a staple discharge port, a staple receiving board for receiving a discharged staple, and a paper placing stand for placing a bound object;
wherein a protruded part is formed near the staple discharge port of the staple storing frame and a recessed part is formed in a position that is on the paper placing stand and corresponds to the protruded part formed in the staple storing frame.

2. The stapler of claim 1, wherein the recessed part is formed to be larger than the protruded part.

3. The stapler of claim 1, wherein the protruded part and the recessed part are formed into a square shape respectively.

4. The stapler of claim 2, wherein the protruded part and the recessed part are formed into a square shape respectively.
